(19) United States
(12) Patent Application Publication
(10) Pub. No.: US 2025/0090289 A1
(43) Pub. Date: Mar. 20, 2025

(54) Personal Care Implement

(71) Applicant: Colgate-Palmolive Company, New York, NY (US)

(72) Inventor: Joppe Gideon VAN DIJK, Rotterdam (NL)

(73) Assignee: Colgate-Palmolive Company, New York, NY (US)

(21) Appl. No.: 18/886,237

(22) Filed: Sep. 16, 2024

Related U.S. Application Data
(60) Provisional application No. 63/539,003, filed on Sep. 18, 2023.

(51) Int. Cl. A61C 17/22

(52) U.S. Cl. CPC A61C 17/222

(57) ABSTRACT

A personal care implement which incorporates a head coupled to a handle. The handle has a motor, a pump operably coupled to the motor, a routing component coupled to the pump, first and second valves, and a controller. The first and second valves are coupled to the routing component. The head has a plurality of cleaning elements and a bladder. The first and second valves are operated by the controller to selectively pressurize and depressurize the bladder by the pump.

### CROSS-REFERENCE TO RELATED APPLICATIONS

The present application claims the benefit of priority to U.S. Provisional Patent Application Ser. No. 63/539,003, filed Sep. 18, 2023, the entirety of which is incorporated herein by reference.

### BACKGROUND

Personal care, particularly care of an individual's teeth and gums, are of utmost importance to ensure overall health. However, typical personal care routines are time consuming. For instance, most dentists recommend brushing teeth for a minimum of two minutes. Those individuals who may have dexterity problems or may not wish to spend the required time brushing may suffer from poor oral health. Similarly, convenient and compact devices for other personal care activities may not exist. Thus, a need exists for personal care implements which remedy the deficiencies in existing products.

### BRIEF SUMMARY

The present invention is directed to a personal care implement having a handle and a head coupled to the handle. The handle has a motor, a pump operably coupled to the motor, a routing component coupled to the pump, a first valve coupled to the routing component, a second valve coupled to the routing component, and a controller. The pump is configured to displace air. The routing component has an outlet port configured to output air and an inlet port configured to intake air. The controller has a processor and a memory and is configured to operate the motor, the first valve, and the second valve. The head has a plurality of cleaning elements and a bladder. The first and second valves are configured to permit selective pressurization or depressurization of the bladder by the pump.

In one aspect, the invention may be a pneumatic module for a personal care implement having a motor, a pump operably coupled to the motor, a routing component coupled to the pump, a manifold component having a connector, a first valve, a second valve, and a controller. The pump is configured to displace air. The routing component has an outlet port configured to output air and an inlet port configured to intake air. The first valve is coupled to the routing component via the manifold component. The second valve is coupled to the routing component via the manifold component. The controller has a processor and a memory, the controller configured to operate the motor, the first valve, and the second valve. The first and second valves are selectively operated to output or intake air at the connector during operation of the pump.

In another aspect, the invention may be a method of operating a personal care implement. The method has a first step of displacing air from a pump via an outlet port of a routing component. The method has a second step of routing the air from the outlet port through a manifold component to a first valve. In a third step, the air is directed from the first valve to a bladder on a head of the personal care implement via the manifold component, causing the bladder to expand in a first state. In a fourth step, the personal care implement switches to a second state, wherein in the second state, the air from the bladder moves through a second valve via the manifold component. In a fifth step, the air is drawn through an inlet port of the routing component and into the pump.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a personal care implement in accordance with a first embodiment of the present invention;

FIG. 2 is a perspective view of the personal care implement of FIG. 1 with a housing removed;

FIG. 3A is a schematic showing the flow routing of the personal care implement of FIG. 1;

FIG. 3B is the schematic showing the personal care implement in a first state;

FIG. 3C is the schematic showing the personal care implement in a second state;

FIG. 4 is a perspective view of a pneumatic module as may be used in the personal care implement of FIG. 1;

FIG. 5 is a front view of the pneumatic module;

FIG. 6 is a rear view of the pneumatic module;

FIG. 7 is a right side view of the pneumatic module;

FIG. 8 is a left side view of the pneumatic module;

FIG. 9 is a top view of the pneumatic module;

FIG. 10 is a bottom view of the pneumatic module;

FIG. 11 is a cross-section view of the pneumatic module taken along line XI-XI of FIG. 4;

FIG. 12 is an exploded view of the pneumatic module;

FIG. 13 is a perspective view of a routing component of the pneumatic module of FIG. 4;

FIG. 14 is a front view of the routing component;

FIG. 15 is a rear view of the routing component;

FIG. 16 is a right side view of the routing component;

FIG. 17 is a left side view of the routing component;

FIG. 18 is a top view of the routing component;

FIG. 19 is a bottom view of the routing component;

FIG. 20 is a cross-section view of the routing component taken along line XX-XX of FIG. 13;

FIG. 21 is a perspective view of a portion of the pneumatic module of FIG. 4;

FIG. 22 is a front view of the portion of the pneumatic module;

FIG. 23 is a rear view of the portion of the pneumatic module;

FIG. 24 is a right side view of the portion of the pneumatic module;

FIG. 25 is a left side view of the portion of the pneumatic module;

FIG. 26 is a top view of the portion of the pneumatic module;

FIG. 27 is a bottom view of the portion of the pneumatic module;

FIG. 28 is a cross-section view of the pneumatic module taken along line XXVIII-XXVIII of FIG. 21;

FIG. 29 is a perspective view of a personal care implement in accordance with a second embodiment of the present invention;

FIG. 30 is a perspective view of the personal care implement of FIG. 29 with a housing removed;

FIG. 31 is a perspective view of a pneumatic module as may be used in the personal care implement of FIG. 29;

FIG. 32 is a front view of the pneumatic module;

FIG. 33 is a rear view of the pneumatic module;

FIG. 34 is a right side view of the pneumatic module;

FIG. 35 is a left side view of the pneumatic module;

FIG. 36 is a top view of the pneumatic module;

FIG. 37 is a bottom view of the pneumatic module;

FIG. 38 is a cross-section view of the pneumatic module taken along line XXXVIII-XXXVIII of FIG. 31;

FIG. 39 is an exploded view of the pneumatic module;

FIG. 40 is a perspective view of a routing component of the pneumatic module of FIG. 31;

FIG. 41 is a front view of the routing component;

FIG. 42 is a rear view of the routing component;

FIG. 43 is a right side view of the routing component;

FIG. 44 is a left side view of the routing component;

FIG. 45 is a top view of the routing component;

FIG. 46 is a bottom view of the routing component;

FIG. 47 is a cross-section view of the routing component taken along line XXXXVII-XXXXVII of FIG. 40;

FIG. 48 is a perspective view of a portion of the pneumatic module of FIG. 31;

FIG. 49 is a front view of the portion of the pneumatic module;

FIG. 50 is a rear view of the portion of the pneumatic module;

FIG. 51 is a right side view of the portion of the pneumatic module;

FIG. 52 is a left side view of the portion of the pneumatic module;

FIG. 53 is a top view of the portion of the pneumatic module;

FIG. 54 is a bottom view of the portion of the pneumatic module;

FIG. 55 is a perspective view of another pneumatic module as may be used in the personal care implement of FIG. 29;

FIG. 56 is a front view of the pneumatic module;

FIG. 57 is a rear view of the pneumatic module;

FIG. 58 is a right side view of the pneumatic module;

FIG. 59 is a left side view of the pneumatic module;

FIG. 60 is a top view of the pneumatic module;

FIG. 61 is a bottom view of the pneumatic module;

FIG. 62 is a cross-section view of the pneumatic module taken along line XXXVIII-XXXVIII of FIG. 31; and

FIG. 63 is an exploded view of the pneumatic module.

### DETAILED DESCRIPTION

The following description of the preferred embodiment(s) is merely exemplary in nature and is in no way intended to limit the invention, its application, or uses.

The description of illustrative embodiments of principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

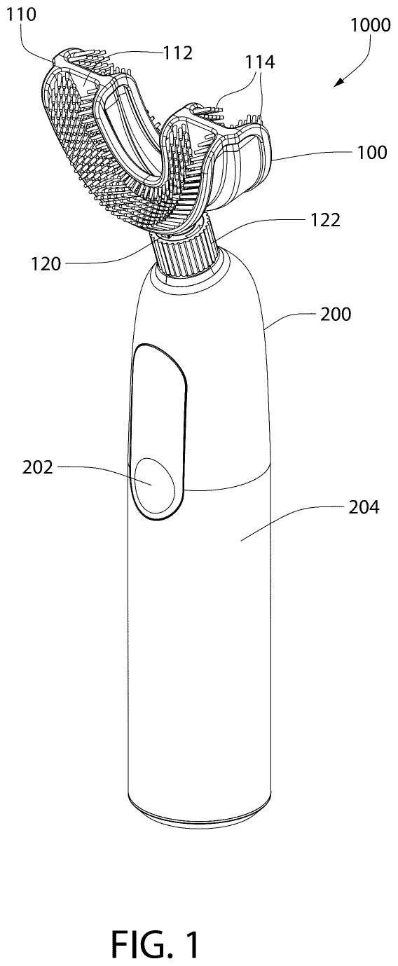

Referring to FIG. 1, a personal care implement 1000 is illustrated in accordance with an embodiment of the present invention. The personal care implement 1000 is a powered oral care device for cleaning a user's teeth and other oral tissues. The personal care implement 1000 has a head 100 and a handle 200. The handle 200 has a user interface 202 and a housing 204. The head 100 has a head portion 110 and a neck portion 120. The neck portion 120 includes a connector 122 which serves to create a fluid-tight connection between the head 100 and the handle 200 as will be discussed further below. The head portion 110 further includes a bladder 112 and a plurality of cleaning elements 114. The connector 122 is in fluid communication with the bladder 112 to allow selective inflation and deflation of the bladder 112. Inflation and deflation of the bladder 112 causes movement of the plurality of cleaning elements 114, which provides cleaning action.

Optionally, the cleaning elements 114 may be conventional filament bristles made from nylon, polybutylene terephthalate (“PBT”), or other known materials for making filaments for oral care or any other type of personal care. In other implementations, the cleaning elements 114 may be elastomeric, such as a thermoplastic elastomer, a rubber, or another similar material. Thus, the cleaning elements 114 may be tufts of filament bristles or may be molded or other tooth cleaning elements.

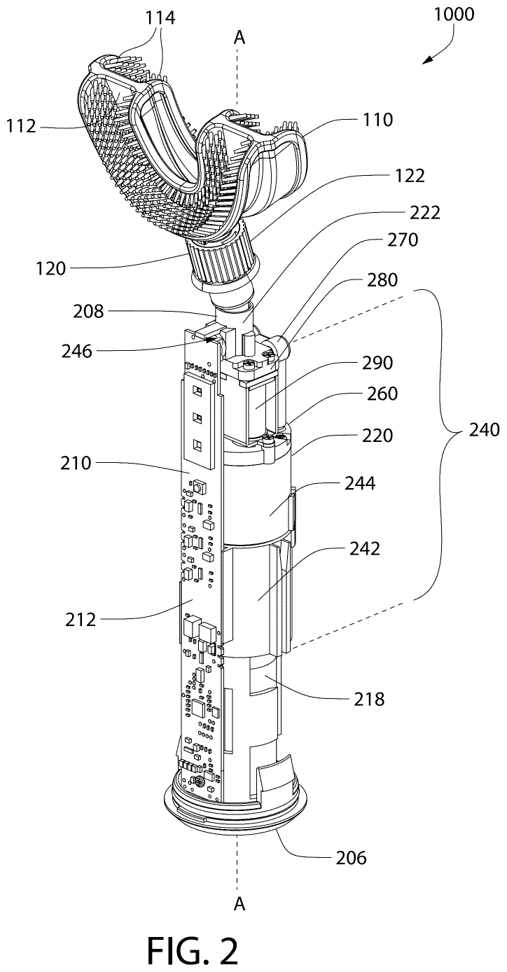

FIG. 2 illustrates the personal care implement 1000 with the housing 204 removed. The handle 200 generally extends along a longitudinal axis A-A. The handle 200 incorporates a controller 210, implemented as a printed circuit board 212 having a processor, a memory, and interface circuitry for receiving user input, outputting information to a user, and controlling and operating various other components of the handle 200 as discussed below. A power source 218 is incorporated into the handle 200 adjacent a proximal end 206 of the handle 200, while a connector 222 is located at a distal end 208 of the handle 200.

The handle 200 has a pneumatic module 240, the pneumatic module 240 configured to displace air, allowing the selective inflation and deflation of the bladder 112. The pneumatic module 240 is constructed of a motor 242, a pump 244, a routing component 260, a tube member 270, a manifold component 280, a pressure sensor 246, and two valves 290. The motor 242 and the valves 290 are controlled by the controller 210. The pump 244 is operably coupled to the motor 242. The routing component 260 is coupled to the pump to direct flow from the pump 244 to the valves 290 via the manifold component 280 and the tube member 270.

In a first state, the pump 244 displaces air which may either be directed, via the valves 290, to the connector 222 to inflate and pressurize the bladder 112. In a second state, the pump 244 may displace air which is directed, via the valves 290, to deflate and depressurize the bladder 112. Thus, the pump 244 may be operated to inflate and pressurize or to deflate or depressurize the bladder 112. In some implementations, the pump 244 may generate a vacuum to facilitate deflation and depressurization. The pump 244 may utilize a housing 220. In some implementations, the housing 220 is directly mated to the routing component 260.

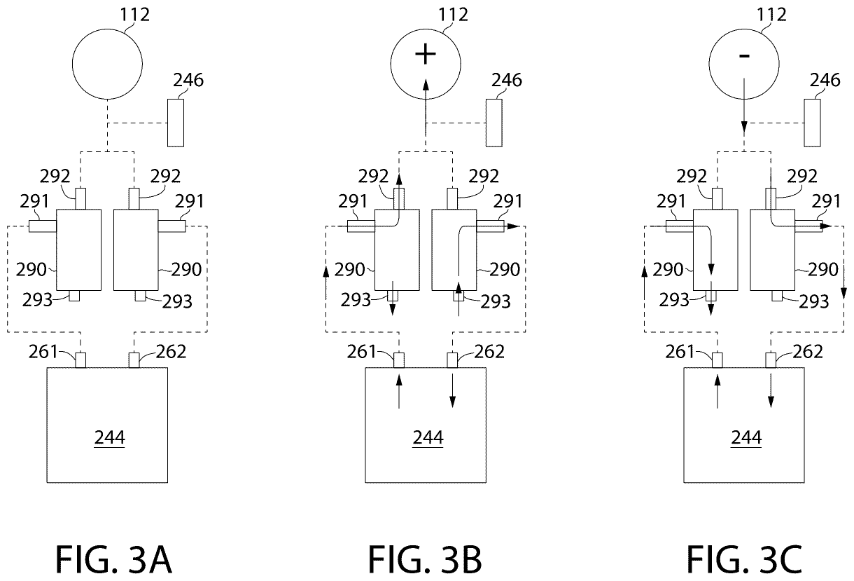

Turning to FIGS. 3A-C, schematic views of the personal care implement 1000 are provided to better illustrate the operation of the pneumatic module 240. The pump 244 is coupled to an outlet port 261 of the routing component 260 and an inlet port 262 of the routing component 260. The inlet and outlet ports 261, 262 serve as inlet and outlet for the pump 244 and are fluidly coupled to first ports 291 of the valves 290. The routing component 260 is not illustrated. Second ports 292 of the valves 290 are fluidly coupled to the bladder 112, with the second ports 292 of the valves 290 in fluid communication with each other. The valves 290 further comprise third ports 293 which are in fluid communication with atmosphere. The pressure sensor 246 is in fluid communication with the second ports 292 and the bladder 112, allowing sampling of the pressure within the bladder 112. Optionally, the pressure sensor 246 may be omitted and the system may operate using pre-programmed pressure profiles, timings, or other parameters. Optionally, a safety valve may be incorporated, particularly where a pressure sensor 246 is omitted.

In a first state illustrated in FIG. 3B, the bladder 112 is inflated. The pump 244 is operated by the motor 242, causing air to be displaced from the outlet port 261 and air drawn into the inlet port 262. The air drawn through the inlet port 262 flows in via the third port 293 of a second one of the valves 290, illustrated at right in the figure. The air then exits the second valve 290 via the first port 291 of the second valve 290. The second port 292 of the second valve 290 is isolated from the first and third ports 291, 293 so that no air flows via the second port 292. In the first state, the second valve 290 is in a state where the first and third ports 291, 293 are in fluid communication while the second port 292 is blocked.

In the first state, air is displaced from the pump 244 via the outlet port 261 to the first port 291 of a first one of the valves 290. The first valve 290 is in a state where the first and second ports 291, 292 are in fluid communication while the third port 293 is blocked. Thus, displaced air from the pump 244 travels through the first port 291 of the first valve 290 to the second port 292 and on to the bladder 112. Thus, the bladder 112 is pressurized and inflated in the first state, with air drawn in via the third port 293 of the second valve 290, through the pump 244, and on to the bladder 112 through the first valve 290.

In a second state illustrated in FIG. 3C, the bladder 112 is deflated. The pump 244 is operated by the motor 242 to cause air to be drawn from the bladder 112. Air from the bladder 112 is drawn through the second port 292 of the second valve 290 at right. The second valve 290 is in a state where the first and second ports 291, 292 are in fluid communication while the third port 293 is blocked. Air flows through the second port 292 to the inlet port 262. Air is then displaced through the outlet port 261, through the first port 291 of the first valve 290 at left. The first valve 290 is in a state where the first and third ports 291, 293 are in fluid communication while the second port 292 is blocked. The air from the pump 244 flows through the first port 291 of the first valve 290 to the third port 293, venting it to the ambient atmosphere.

It is contemplated that the personal care implement 1000 may switch between the first and second states to excite the cleaning elements 114 and allow effective cleaning action. This may be done at high frequency to generate high frequency motion in the cleaning elements 114. The frequency and duration of each of the first and second states may vary to provide different oscillation impulses. It is further conceived that this system may be expanded to service a plurality of bladders 112 to create different motions in different regions of the head 100. It is also contemplated that a single valve 290 may be utilized, with the bladder 112 selectively pressurized or vented to atmosphere, with the bladder 112 deflating when vented to atmosphere.

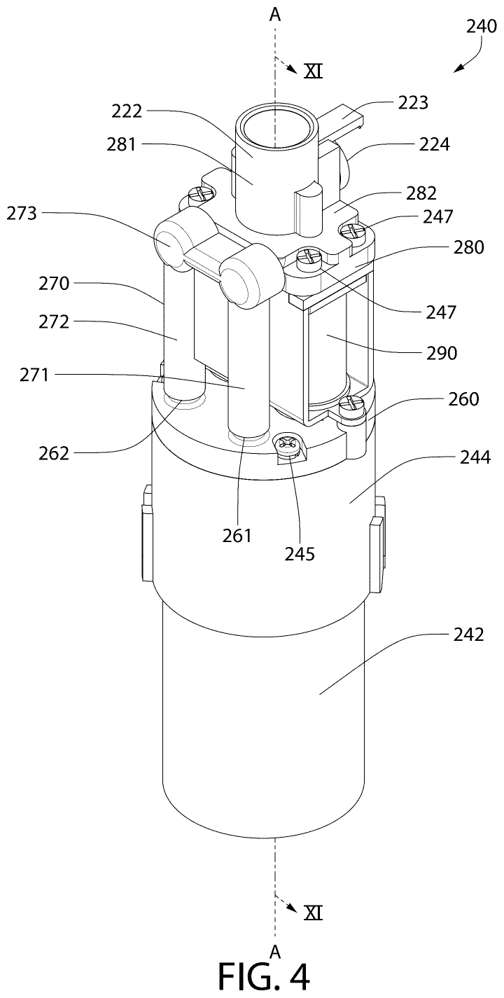

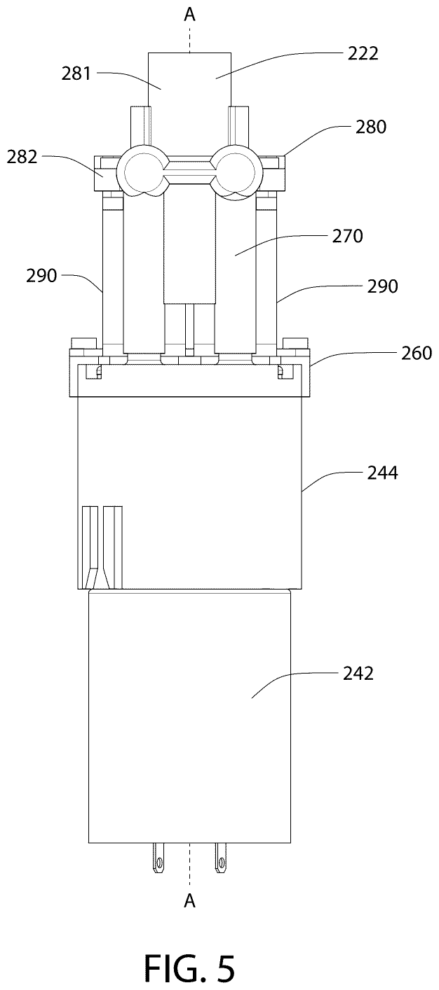

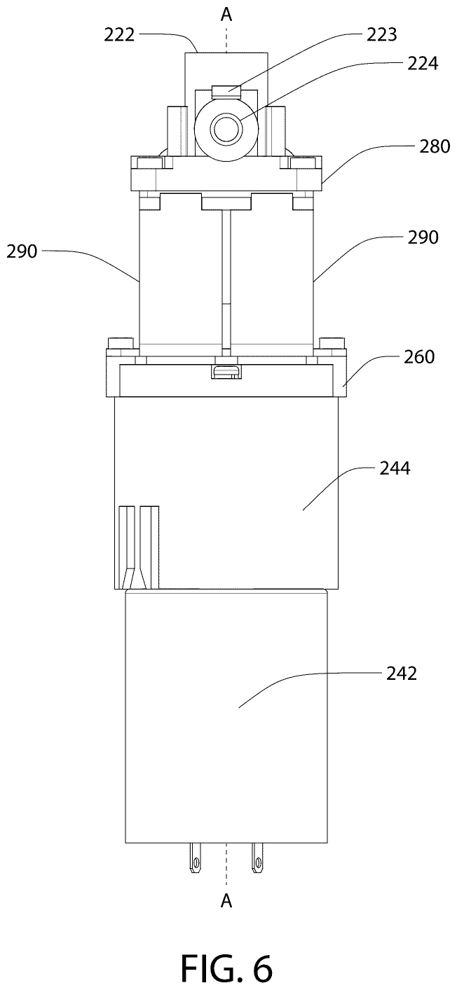

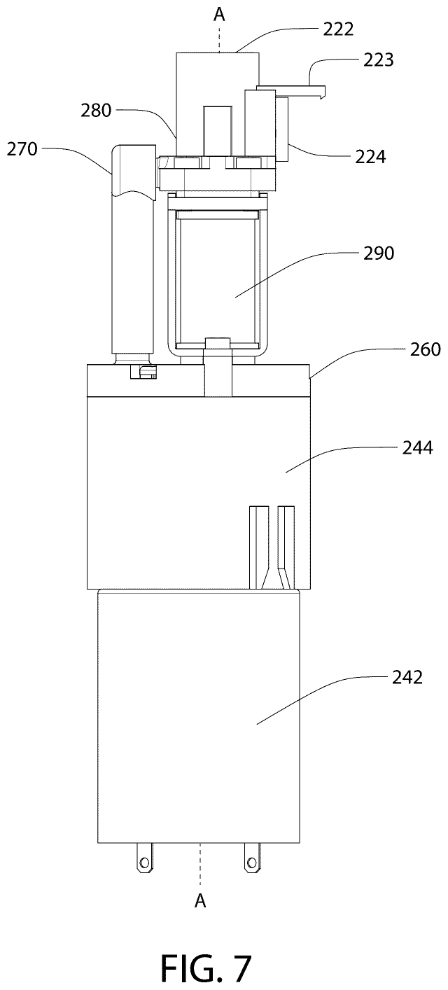

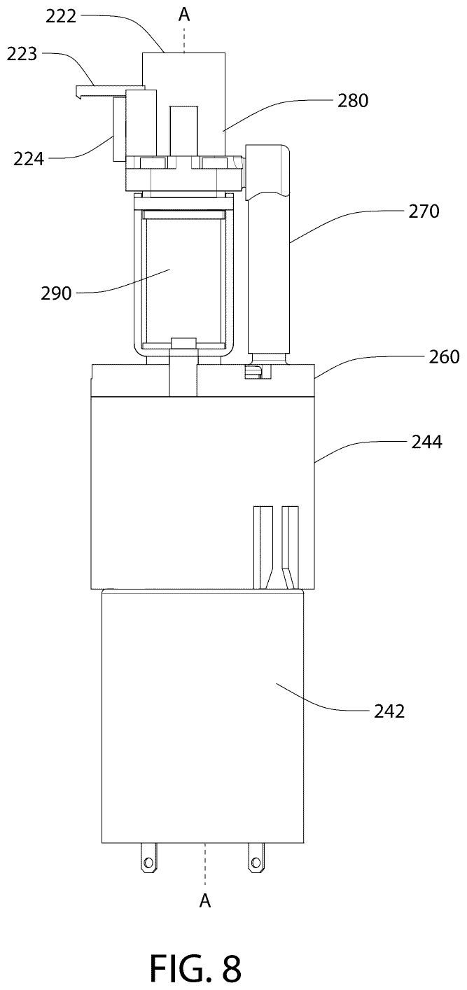

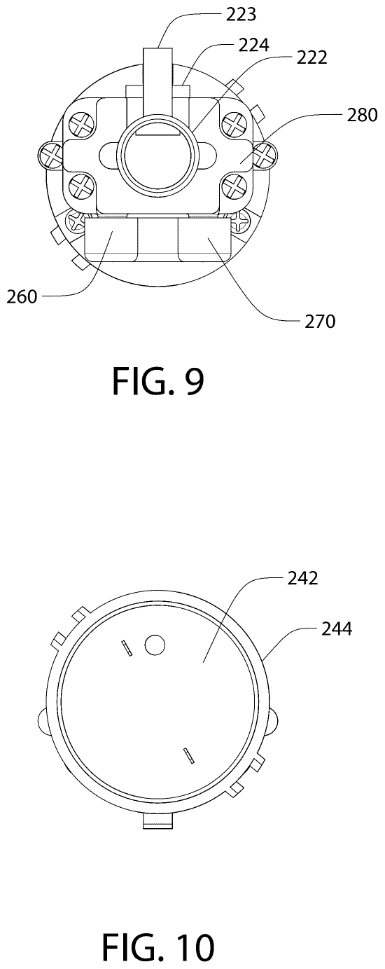

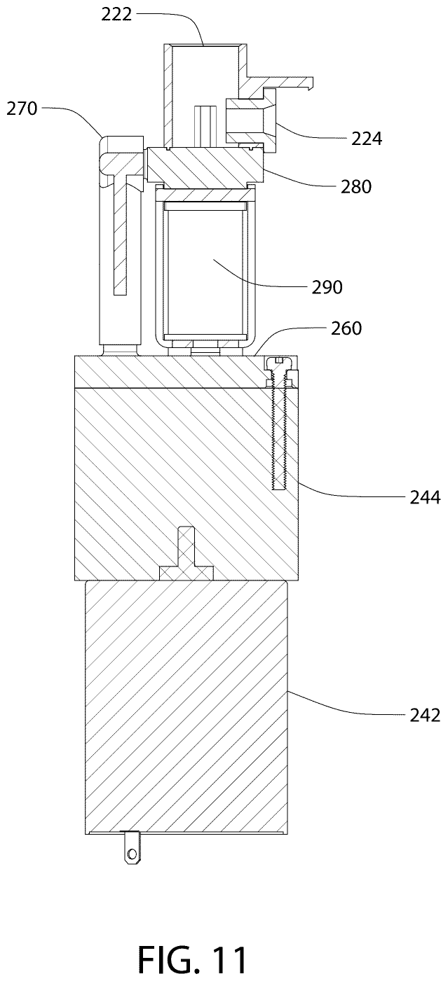

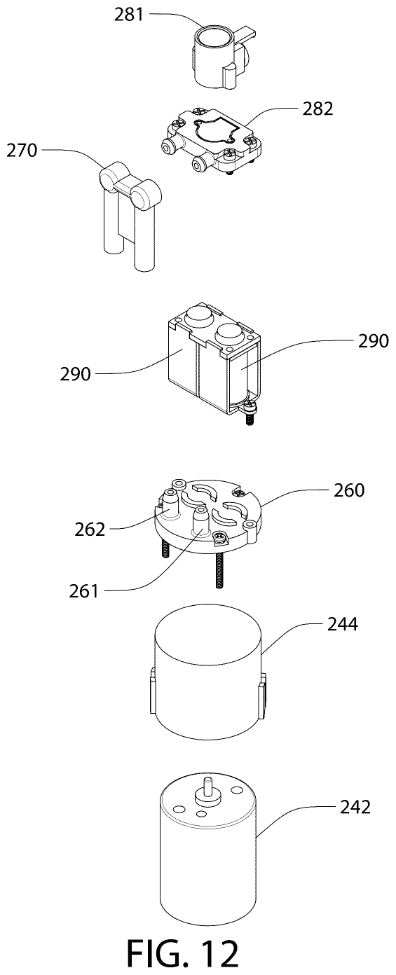

Turning to FIGS. 4-12, the pneumatic module 240 is illustrated in greater detail. As discussed above, the pneumatic module 240 includes the motor 242, pump 244, routing component 260, tube member 270, manifold component 280, pressure sensor 246, and two valves 290. The longitudinal axis A-A extends through the pneumatic module 240. The motor 242 may be an electric motor such as a DC electric motor, and may have a shaft which is coupled to the pump 244 to drive the pump 244 and displace air. Optionally, the motor 242 may be a universal motor, induction motor, or other type of motor as desired. The pump 244 may be any known type of pump, including a diaphragm pump, peristaltic pump, piston pump, vane pump, centrifugal pump, or the like. Preferably, the pump 244 and motor 242 are compact, allowing creation of a compact package which is easily packaged within the handle 200. In some implementations, the pump may be a mini air pump or rotary diaphragm pump. In addition, the valves 290 may be referred to as 3/2 solenoid valves because they have two positions and three ports and are operated by a solenoid. In other implementations, the valves 290 may be 5/2 or 5/3 valves, and may or may not be solenoid valves.

The routing component 260 mounts to the pump 244 and incorporates the inlet and outlet ports 261, 262 which direct flow into and out of the pump 244. Optionally, the routing component 260 may be formed as a part of the pump 244, or it may be formed separately and attached by a plurality of fasteners 245 as illustrated. The routing component 260 will be discussed in greater detail below.

The tube member 270 connects the inlet and outlet ports 261, 262 to the manifold component 280 to allow passage of air between the pump 244 and the valves 290. The manifold component 280 has a first fluid pathway 271 and a second fluid pathway 272 formed within a body 273. Optionally, the body 273 may be a unitary, integrally formed, component. In other implementations the body 273 may be formed as multiple separate components.

The manifold component 280 couples the tube member 270 to the valves 290, and also incorporates the connector 222 which couples to the connector 122 of the head 100. The manifold component 280 may be formed in an upper portion 281 and a lower portion 282 which are joined together. The upper portion 281 and lower portion 282 may be joined via adhesive, ultrasonic welding, plastic welding, fasteners, or any known method. Preferably, the upper portion 281 and the lower portion 282 are joined in a fluid-tight manner to ensure no leakage of air during operation.

The upper portion 281 incorporates the connector 222, a retention feature 223 for the controller 210, and a sensor port 224. The retention feature 223 may be a snap feature, a pin, or other feature which aids in retention of the printed circuit board 212 prior to installation of the housing 204. The sensor port 224 is in fluid communication with the connector 222, and enables the pressure sensor 246 to sample pressure within the passageway connecting the second ports 292 of the valves 290 with the connector 222 and the bladder 112.

The lower portion 282 mates to the valves 290 and the tube member 270, allowing fluid connections between the valves 290 and the inlet and outlet ports 261, 262 of the routing component 260. The lower portion 282 is fastened to the valves 290 via additional fasteners 247. In other implementations, the manifold component 280 may be glued, welded, press-fit, or otherwise coupled to the valves 290 without the need for fasteners 247.

As shown, the valves 290 and the tube member 270 extend substantially parallel with respect to the longitudinal axis, overlapping along substantially the entire length of the valves 290. The valves 290 are sandwiched between the routing component 260 and the manifold component 280, ensuring compact packaging of the pneumatic module 240. The valves 290 also provide structure to the pneumatic module 240, allowing the manifold component 280 and the routing component 260 to be assembled without requiring that they separately provide strength to the pneumatic module 240. The manifold component 280 and the routing component 260 can be spaced and isolated from each other by the valves 290 and the tube member 270.

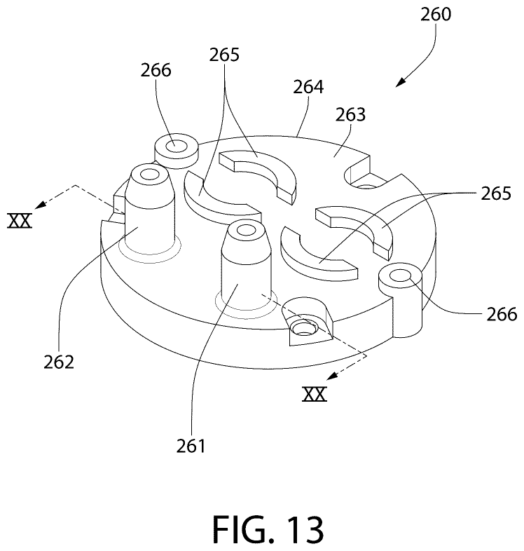

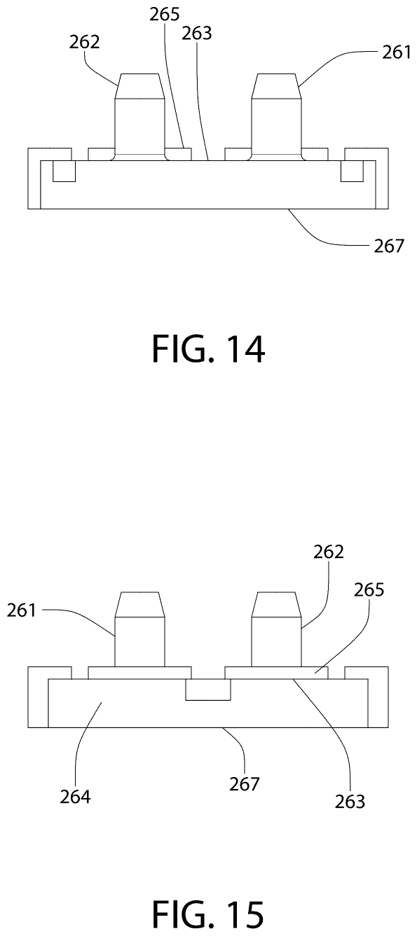

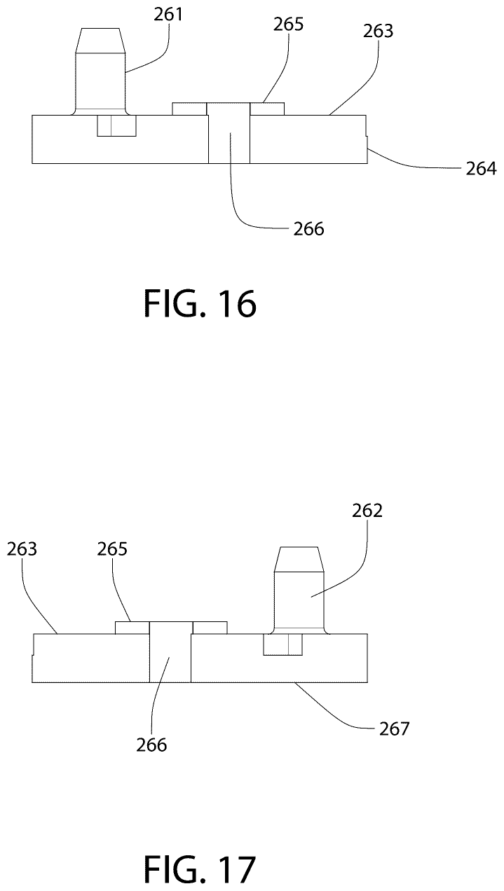

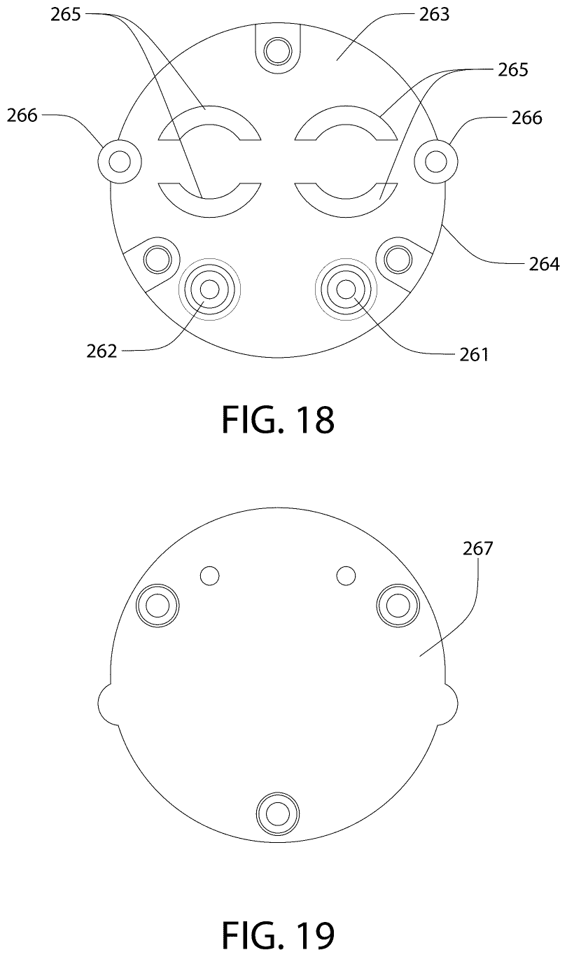

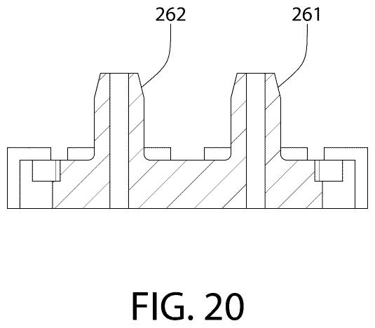

The routing component 260 is illustrated in greater detail in FIGS. 13-20. The routing component 260 incorporates the inlet and outlet ports 261, 262 extending from a top surface 263 of a body 264 of the routing component 260. An opposite bottom surface 267 engages the pump 244 and provides a fluid-tight seal between the pump 244 and the routing component 260. Protuberances 265 also extend from the top surface 263, the protuberances 265 ensuring that the third ports 293 of the valves 290 are open to atmosphere when the valves 290 are mounted onto the top surface 263 of the routing component 260. Fastening features 266 are formed which allow coupling of the valves 290 to the routing component 260. Thus, the valves 290 can be coupled to the routing component 260 while occupying a minimum of space, particularly with respect to the longitudinal axis A-A.

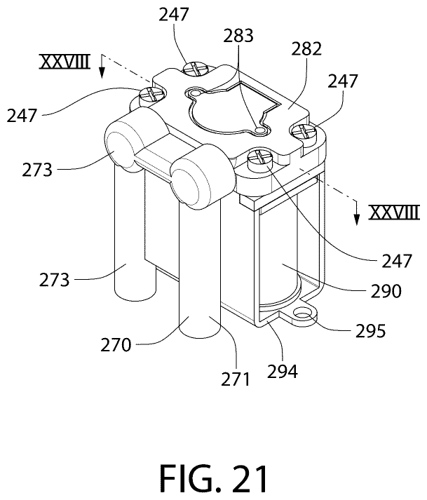

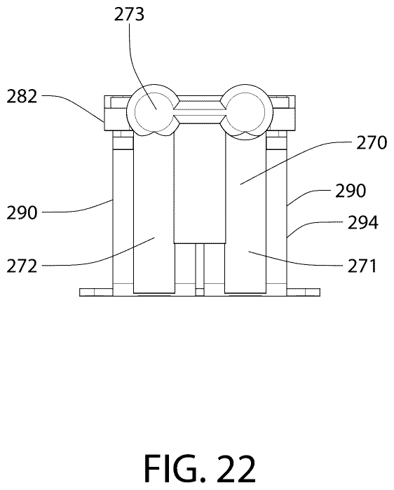

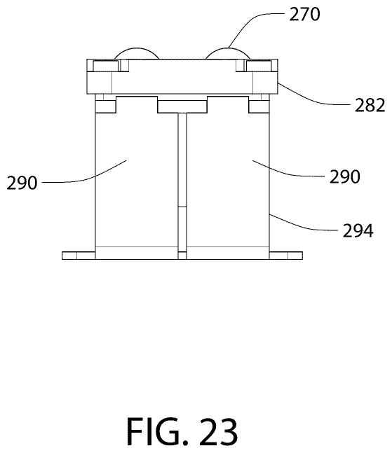

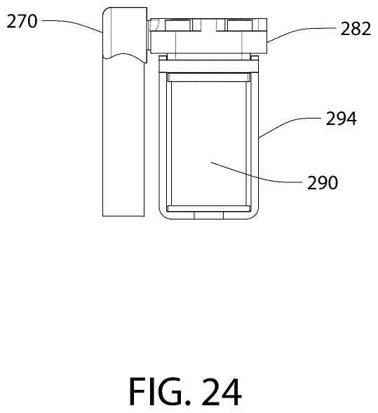

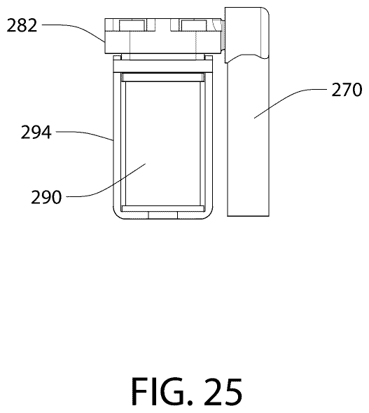

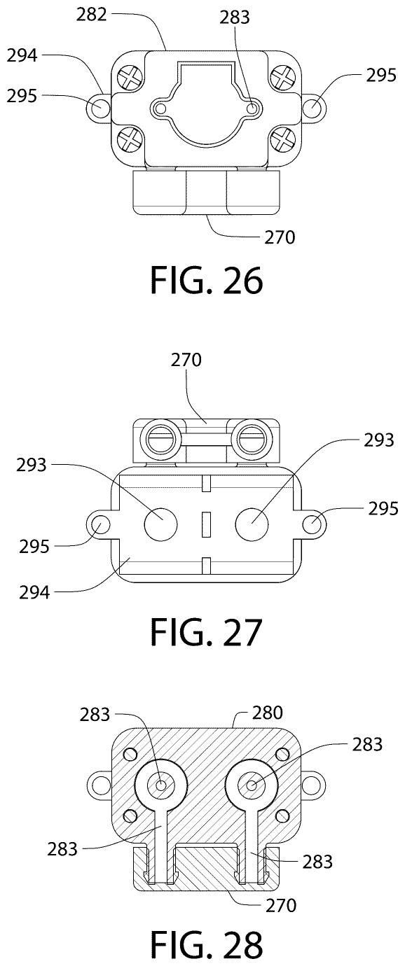

FIGS. 21-28 illustrate the lower portion 282 of the manifold component 280, the valves 290, and the tube member 270. The valves 290 have a housing 294, the housing 294 containing the two valves 290 and providing structural stability for the valves 290 and the manifold component 280. As illustrated, the housing 294 has a plurality of mounting features 295 which allow coupling of the valves 290 to the routing component 260. The housing 294 also receives fasteners 247 of the manifold component 280. This allows the manifold component 280 and the valves 290 to be fixed into one assembly. The tube member 270 extends parallel to the valves 290 with respect to the longitudinal axis A-A as discussed above.

It should be noted that the tube member 270 allows separate connection between the first ports 291 of the valves 290 and the inlet and outlet ports 261, 262 via the first and second fluid pathways 271, 272 formed in the body 273. The body 273 may or may not be formed as a monolithic, integrally formed, component. Optionally, the body 273 may be formed in two separate parts, or it may be formed as a monolithic component. The tube member 270 is configured to slide or snap onto the outlet ports 261, 262. Similarly, the tube member 270 is configured to slide or snap onto manifold component 280. The tube member 270 is configured to make a fluid-tight connection with the outlet ports 261, 262 and the manifold component 280.

The manifold component 280 has a plurality of passages 283, the passages 283 extending between ports of the valves 290, the connector 222, and the first and second fluid pathways 271, 272 of the tube member 270. The manifold component 280 connects the first and second ports 291, 292 of the valves 290 as discussed above. The third ports 293 exit out the bottom of the valves 290, allowing connection with the atmosphere. In some embodiments, the passages 283 may also form the ports 291, 292, 293.

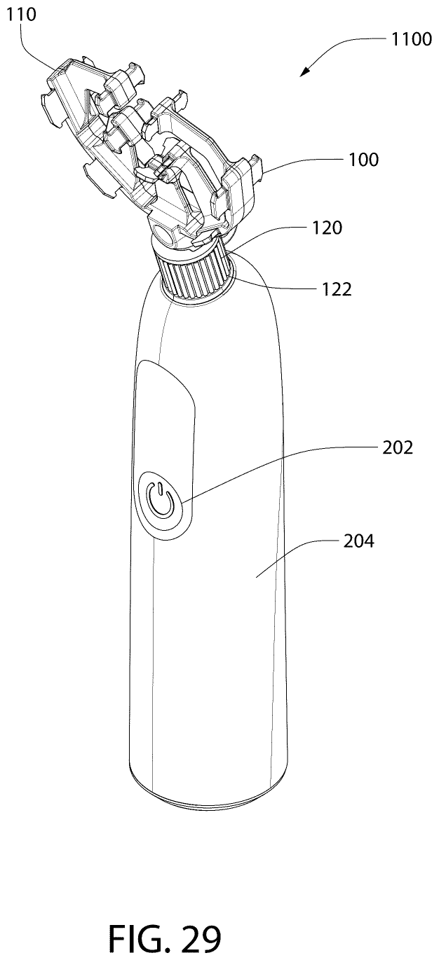

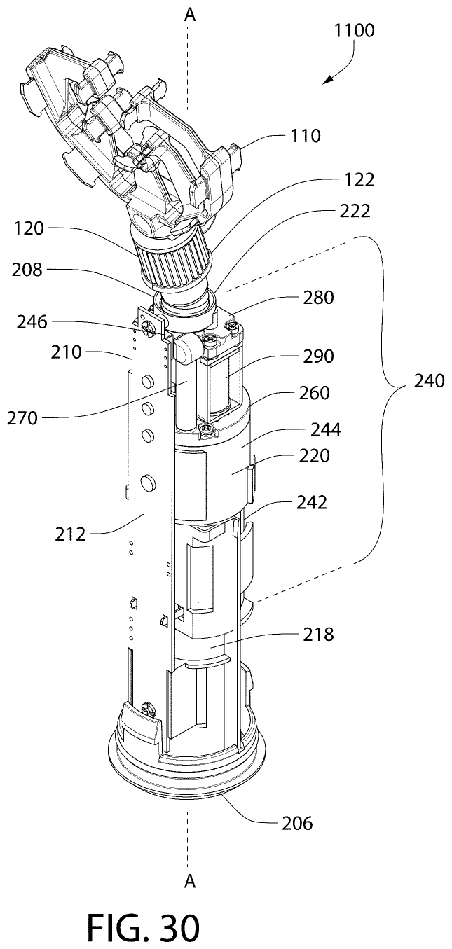

Turning to FIGS. 29 and 30, a second embodiment of an personal care implement 1100 is illustrated. The personal care implement 1100 is also a powered oral care device for cleaning a user's teeth and other oral tissues. The reference numerals for the personal care implement 1100 are identical to those of the personal care implement 1000 except as noted. The personal care implement 1100 has a head 100 and a handle 200. The handle 200 has a user interface 202 and a housing 204. The head 100 has a head portion 110 and a neck portion 120. The neck portion 120 includes a connector 122 which serves to create a fluid-tight connection between the head 100 and the handle 200 as will be discussed further below. The head portion 110 further includes a bladder and a plurality of cleaning elements (not shown in this embodiment). The connector 122 is in fluid communication with the bladder 112 to allow selective inflation and deflation of the bladder 112. Inflation and deflation of the bladder 112 causes movement of the plurality of cleaning elements 114, which provides cleaning action.

Optionally, the cleaning elements 114 may be conventional filament bristles made from nylon, polybutylene terephthalate (“PBT”), or other known materials for making filaments for oral care. In other implementations, the cleaning elements 114 may be elastomeric, such as a thermoplastic elastomer, a rubber, or another similar material. Thus, the cleaning elements 114 may be tufts of filament bristles or may be molded or other tooth cleaning elements.

FIG. 30 illustrates the personal care implement 1100 with the housing 204 removed. The handle 200 generally extends along a longitudinal axis A-A. The handle 200 incorporates a controller 210, implemented as a printed circuit board 212 having a processor, a memory, and interface circuitry for receiving user input, outputting information to a user, and controlling and operating various other components of the handle 200 as discussed below. A power source 218 is incorporated into the handle 200 adjacent a proximal end 206 of the handle 200, while a connector 222 is located at a distal end 208 of the handle 200.

The handle 200 has a pneumatic module 240, the pneumatic module 240 configured to displace air, allowing the selective inflation and deflation of the bladder 112. The pneumatic module 240 is constructed of a motor 242, a pump 244, a routing component 260, a tube member 270, a manifold component 280, a pressure sensor 246, and two valves 290. The motor 242 and the valves 290 are controlled by the controller 210. The pump 244 is operably coupled to the motor 242. The routing component 260 is coupled to the pump to direct flow from the pump 244 to the valves 290 via the manifold component 280 and the tube member 270.

In a first state, the pump 244 displaces air which may either be directed, via the valves 290, to the connector 222 to inflate and pressurize the bladder 112. In a second state, the pump 244 may displace air which is directed, via the valves 290, to deflate and depressurize the bladder 112. Thus, the pump 244 may be operated to inflate and pressurize or to deflate or depressurize the bladder 112. In some implementations, the pump 244 may generate a vacuum to facilitate deflation and depressurization. The pump 244 may utilize a housing 220. In some implementations, the housing 220 is directly mated to the routing component 260. The personal care implement 1100 has the same schematic configuration shown above in FIGS. 3A-C, with the personal care implement 1100 transitioning from the first state to the second state in the same manner as the personal care implement 1000.

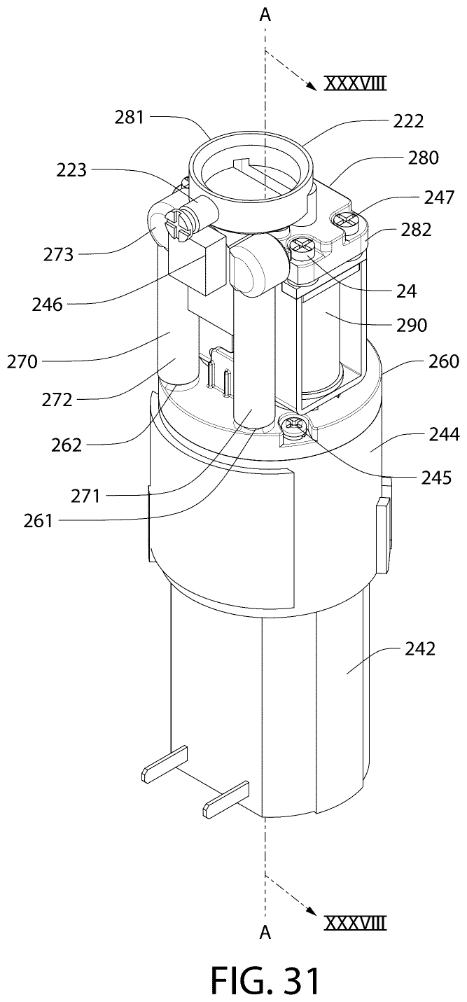

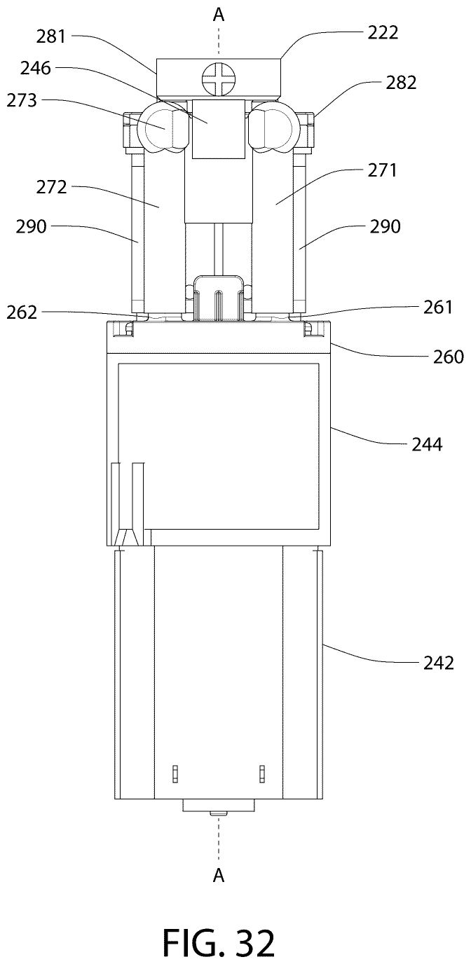

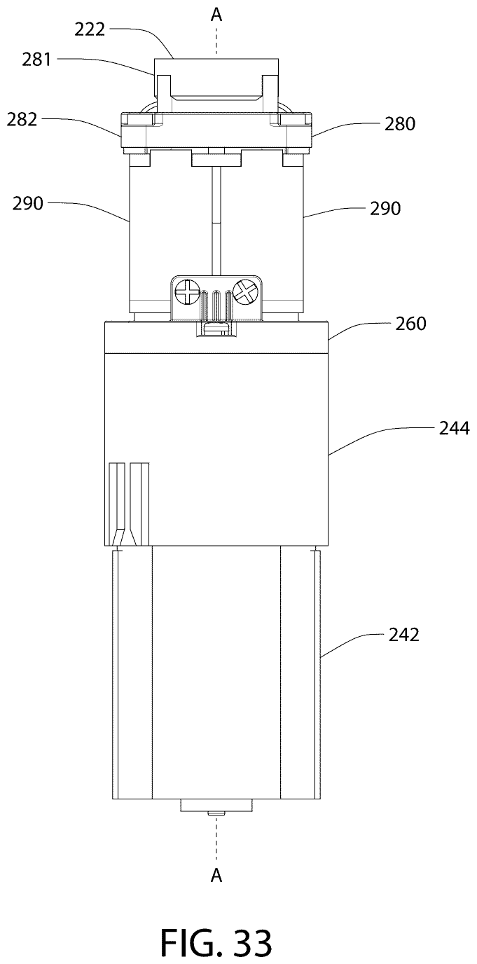

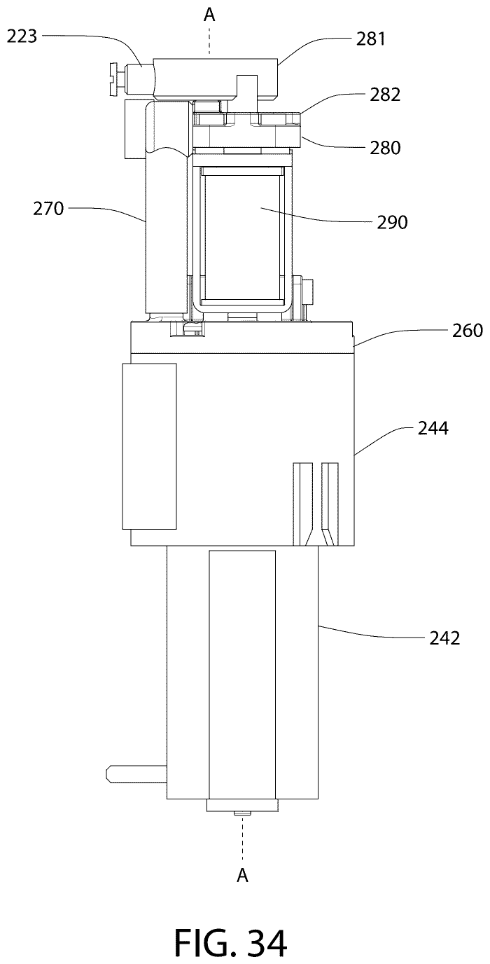

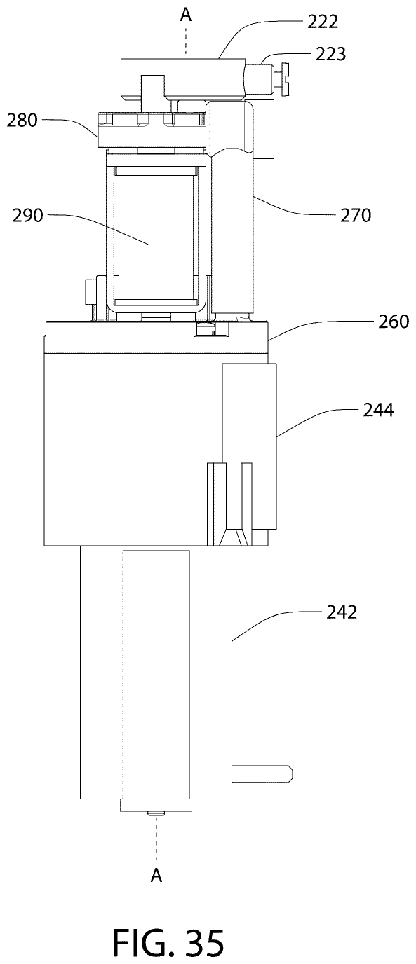

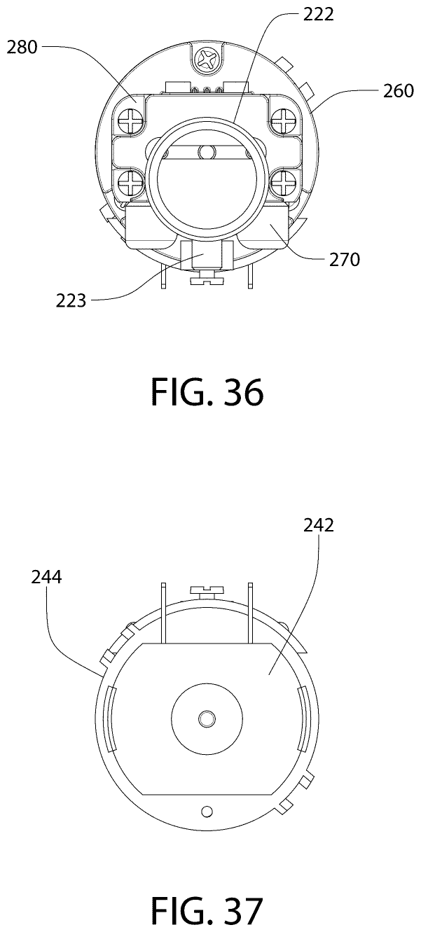

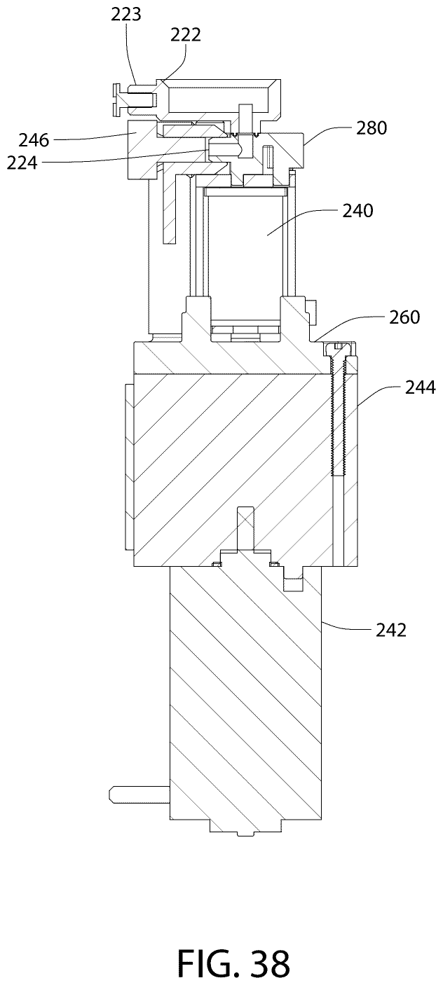

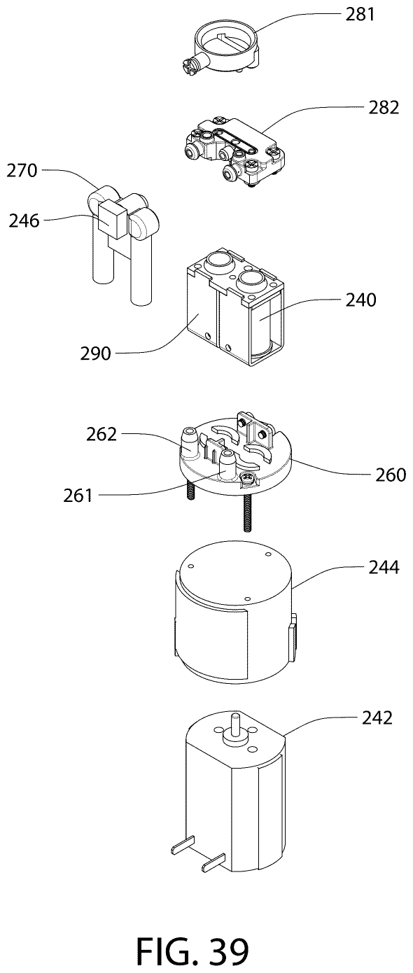

Turning to FIGS. 31-39, the pneumatic module 240 is illustrated in greater detail. As discussed above, the pneumatic module 240 includes the motor 242, pump 244, routing component 260, tube member 270, manifold component 280, pressure sensor 246, and two valves 290. The longitudinal axis A-A extends through the pneumatic module 240. The motor 242 may be an electric motor such as a DC electric motor, and may have a shaft which is coupled to the pump 244 to drive the pump 244 and displace air. Optionally, the motor 242 may be a universal motor, induction motor, or other type of motor as desired. The pump 244 may be any known type of pump, including a diaphragm pump, peristaltic pump, piston pump, vane pump, centrifugal pump, or the like. Preferably, the pump 244 and motor 242 are compact, allowing creation of a compact package which is easily packaged within the handle 200. In some implementations, the pump may be a mini air pump or rotary diaphragm pump.

The routing component 260 mounts to the pump 244 and incorporates the inlet and outlet ports 261, 262 which direct flow into and out of the pump 244. Optionally, the routing component 260 may be formed as a part of the pump 244, or it may be formed separately and attached by a plurality of fasteners 245 as illustrated. The routing component 260 will be discussed in greater detail below.

The tube member 270 connects the inlet and outlet ports 261, 262 to the manifold component 280 to allow passage of air between the pump 244 and the valves 290. The manifold component 280 has a first fluid pathway 271 and a second fluid pathway 272 formed within a body 273. Optionally, the body 273 may be a unitary, integrally formed, component. In other implementations the body 273 may be formed as multiple separate components. In the present embodiment, the tube member 270 incorporates mounting features for the pressure sensor 246.

The manifold component 280 couples the tube member 270 to the valves 290, and also incorporates the connector 222 which couples to the connector 122 of the head 100. The manifold component 280 may be formed in an upper portion 281 and a lower portion 282 which are joined together. The upper portion 281 and lower portion 282 may be joined via adhesive, ultrasonic welding, plastic welding, fasteners, or any known method. Preferably, the upper portion 281 and the lower portion 282 are joined in a fluid-tight manner to ensure no leakage of air during operation. In addition, the manifold component 280 incorporates a sensor port 224. The tube member 270 couples to the sensor port 224 in a fluid-tight manner, allowing sensing by the pressure sensor 246 via the sensor port 224 of the manifold component 280.

The upper portion 281 incorporates the connector 222 and a retention feature 223 for the controller 210. The retention feature 223 may be a threaded or unthreaded hole, or may be a snap feature, a pin, or other feature which aids in retention of the printed circuit board 212 prior to installation of the housing 204.

The lower portion 282 mates to the valves 290 and the tube member 270, allowing fluid connections between the valves 290 and the inlet and outlet ports 261, 262 of the routing component 260. The lower portion 282 is fastened to the valves 290 via additional fasteners 247.

In other implementations, the manifold component 280 may be glued, welded, press-fit, or otherwise coupled to the valves 290 without the need for fasteners 247. In addition, the sensor port 224 is formed in the lower portion 282. The sensor port 224 is in fluid communication with the connector 222, and enables the pressure sensor 246 to sample pressure within the passageway connecting the second ports 292 of the valves 290 with the connector 222 and the bladder 112.

As shown, the valves 290 and the tube member 270 extend substantially parallel with respect to the longitudinal axis, overlapping along substantially the entire length of the valves 290. The valves 290 are sandwiched between the routing component 260 and the manifold component 280, ensuring compact packaging of the pneumatic module 240. The valves 290 also provide structure to the pneumatic module 240, allowing the manifold component 280 and the routing component 260 to be assembled without requiring that they separately provide strength to the pneumatic module 240. The manifold component 280 and the routing component 260 can be spaced and isolated from each other by the valves 290 and the tube member 270.

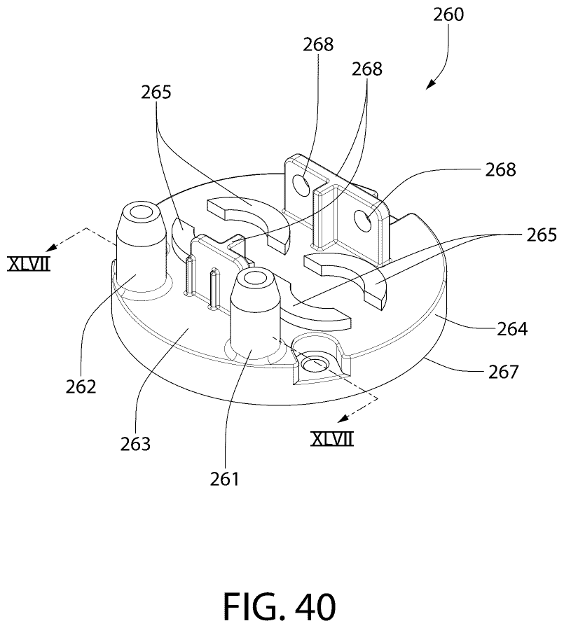

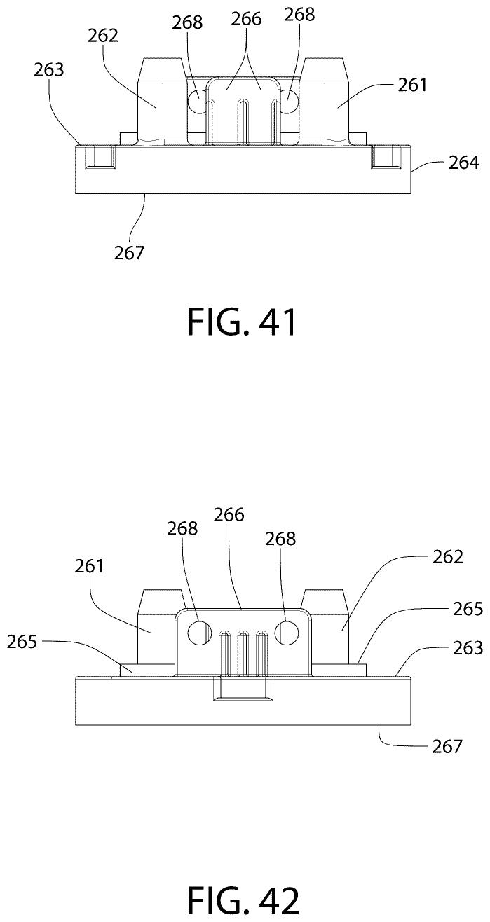

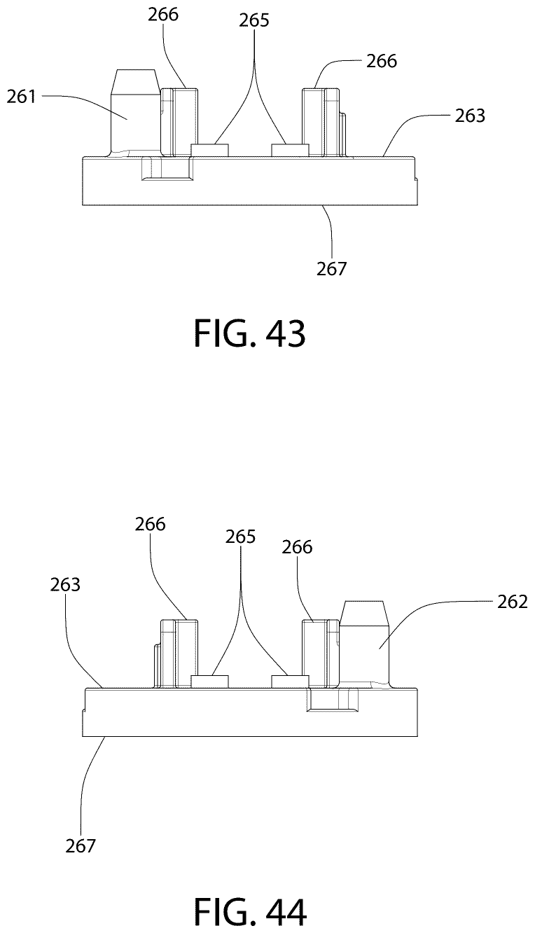

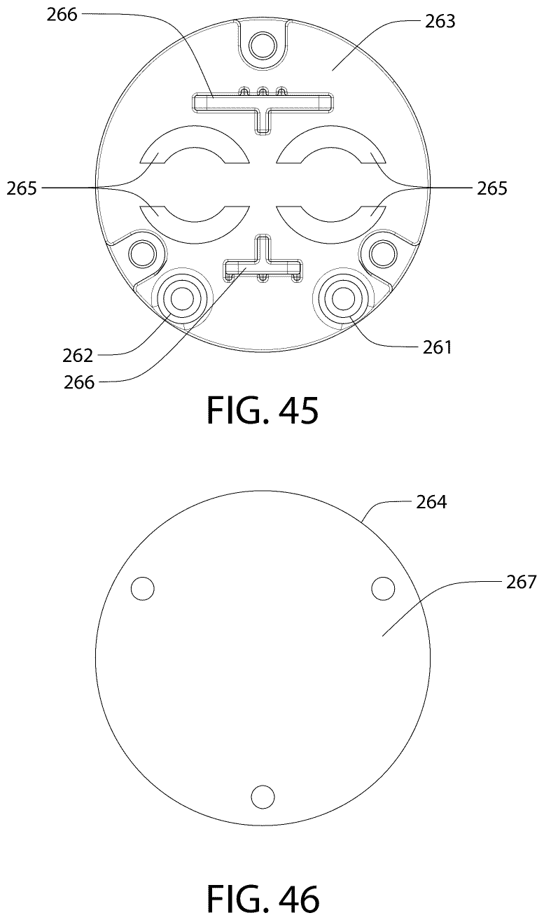

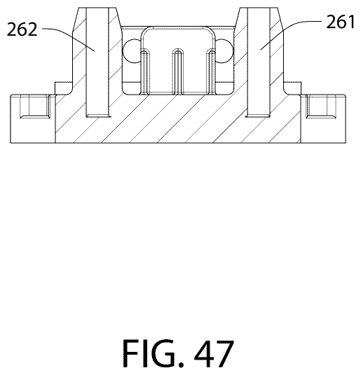

The routing component 260 is illustrated in greater detail in FIGS. 40-47. The routing component 260 incorporates the inlet and outlet ports 261, 262 extending from a top surface 263 of a body 264 of the routing component 260. An opposite bottom surface 267 engages the pump 244 and provides a fluid-tight seal between the pump 244 and the routing component 260. Protuberances 265 also extend from the top surface 263, the protuberances 265 ensuring that the third ports 293 of the valves 290 are open to atmosphere when the valves 290 are mounted onto the top surface 263 of the routing component 260. Fastening features 266 are formed which allow coupling of the valves 290 to the routing component 260. Thus, the valves 290 can be coupled to the routing component 260 while occupying a minimum of space, particularly with respect to the longitudinal axis A-A. The fastening features 266 may receive the valves 290 and may further incorporate fastener passageways 268 which allow coupling of the valves 290 to the fastening features 266. Optionally, the fastening features 266 may be in direct surface contact with a bottom surface of the valves 290 or peripheral surfaces of the valves 290 to provide stability and rigid coupling of the valves 290 to the routing component 260.

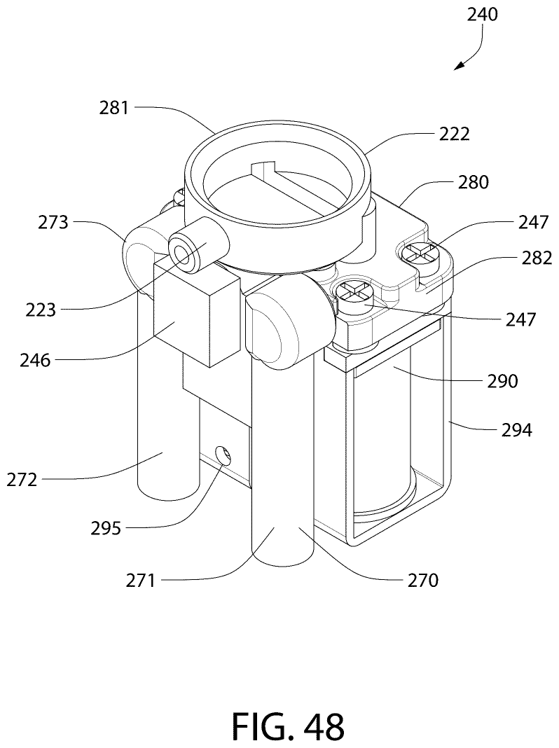

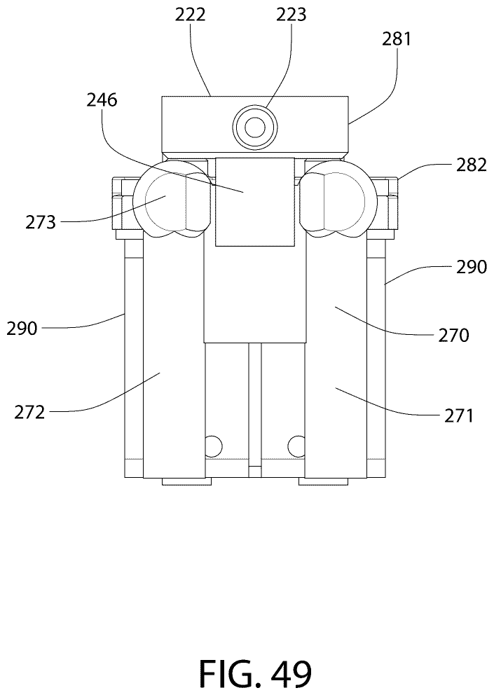

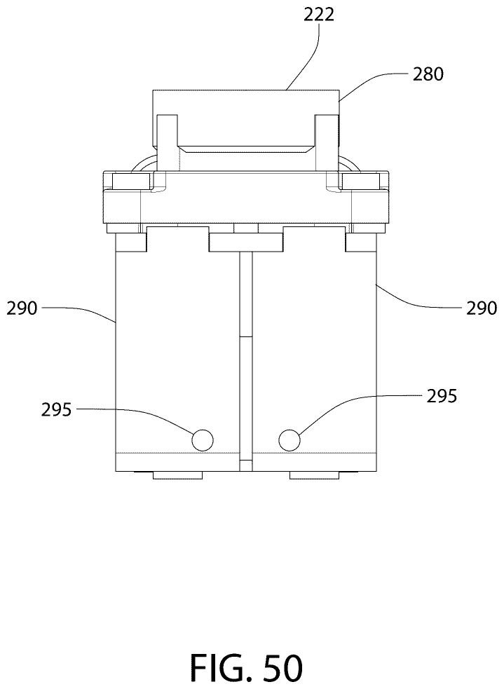

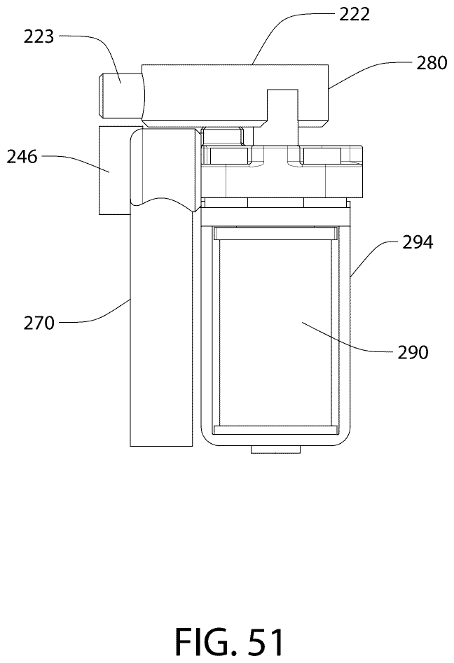

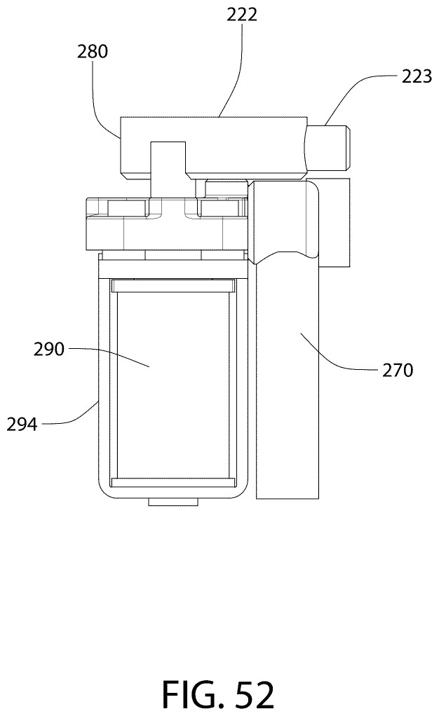

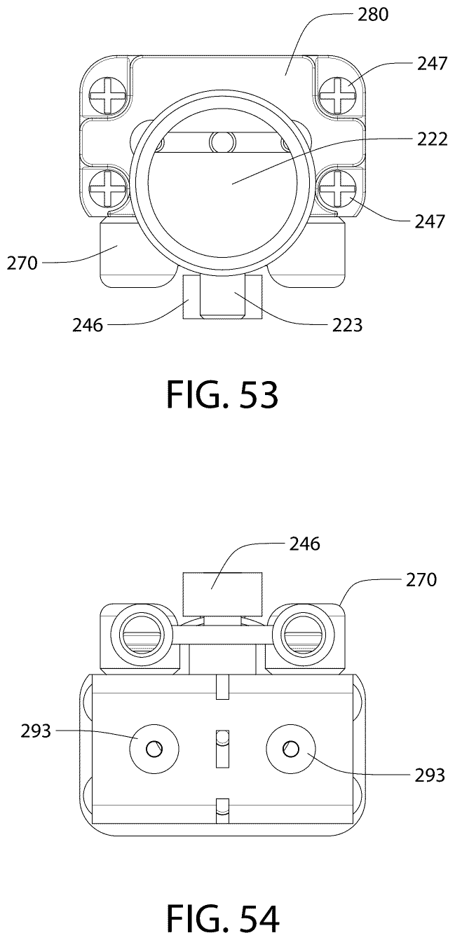

FIGS. 48-55 illustrate the manifold component 280, the valves 290, the tube member 270, and the pressure sensor 246. The valves 290 have a housing 294, the housing 294 containing the two valves 290 and providing structural stability for the valves 290 and the manifold component 280. As illustrated, the housing 294 has a plurality of mounting features 295 which allow coupling of the valves 290 to the routing component 260. The housing 294 also receives fasteners 247 of the manifold component 280. This allows the manifold component 280 and the valves 290 to be fixed into one assembly. The tube member 270 extends parallel to the valves 290 with respect to the longitudinal axis A-A as discussed above.

It should be noted that the tube member 270 allows separate connection between the first ports 291 of the valves 290 and the inlet and outlet ports 261, 262 via the first and second fluid pathways 271, 272 formed in the body 273. The body 273 may or may not be formed as a monolithic, integrally formed, component. Optionally, the body 273 may be formed in two separate parts, or it may be formed as a monolithic component. The tube member 270 is configured to slide or snap onto the outlet ports 261, 262. Similarly, the tube member 270 is configured to slide or snap onto manifold component 280. The tube member 270 is configured to make a fluid-tight connection with the outlet ports 261, 262 and the manifold component 280. The tube member 270 further receives the pressure sensor 246 and has a fluid-tight connection to the manifold component 280 to allow coupling the pressure sensor 246 to the sensor port 224 of the manifold component 280.

The manifold component 280 has a plurality of passages 283, the passages 283 extending between ports of the valves 290, the connector 222, and the first and second fluid pathways 271, 272 of the tube member 270. The manifold component 280 connects the first and second ports 291, 292 of the valves 290 as discussed above. The third ports 293 exit out the bottom of the valves 290, allowing connection with the atmosphere. The manifold component 280 is formed of the upper portion 281 and the lower portion 282 as discussed above.

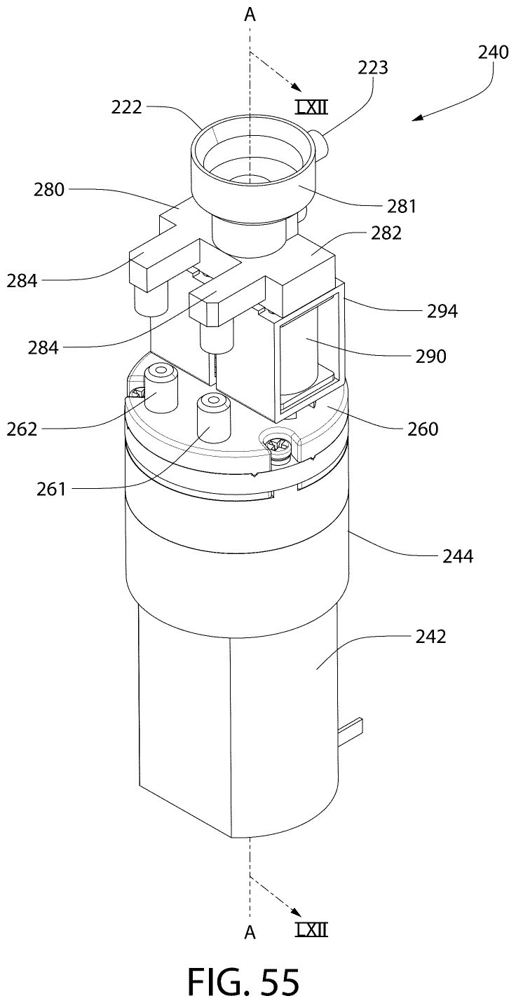

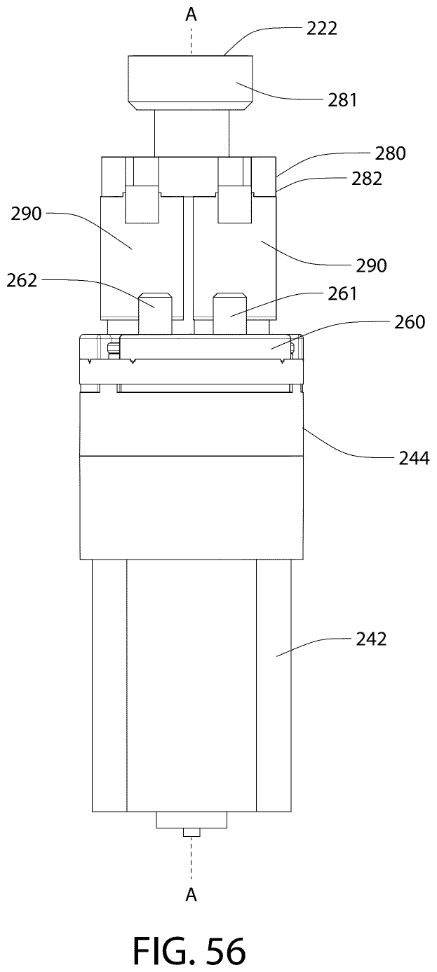

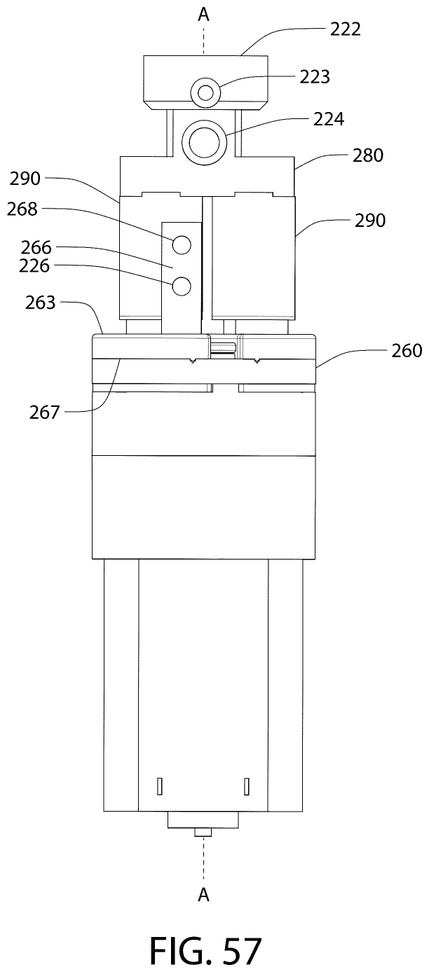

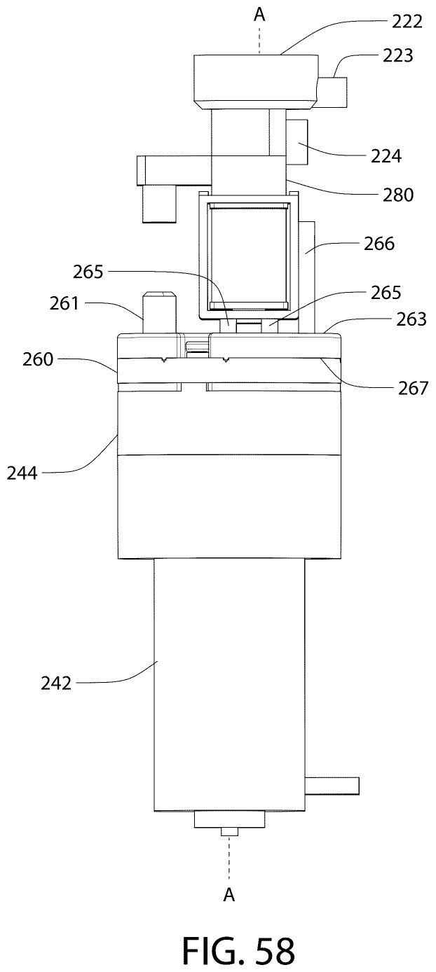

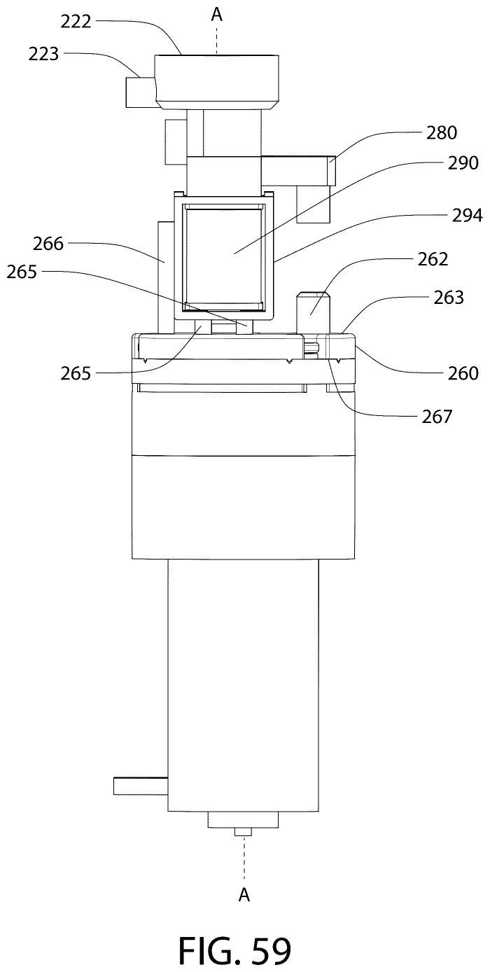

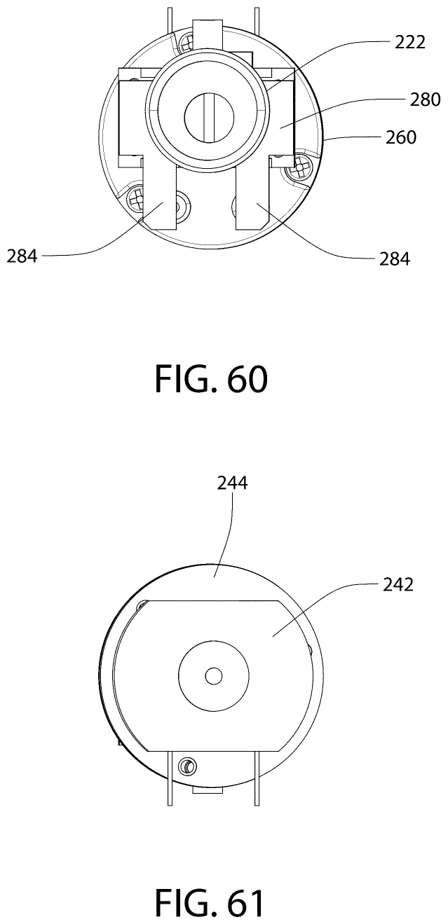

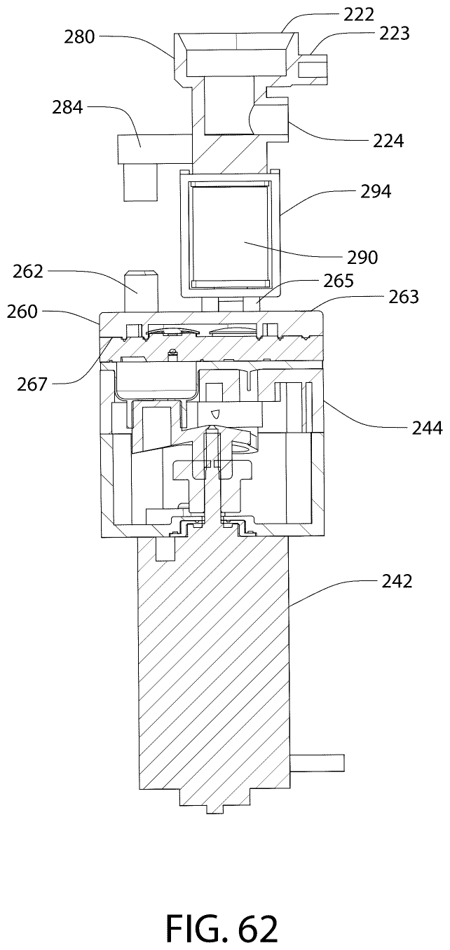

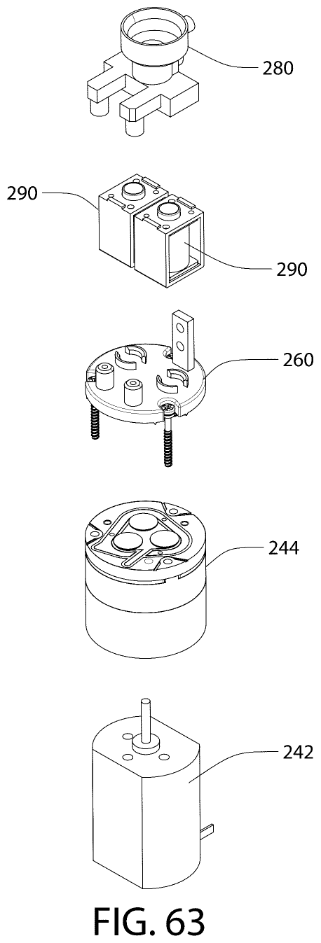

FIGS. 55 to 63 illustrate a third embodiment of a pneumatic module 240 extending along a longitudinal axis A-A, with the tube member 270 and pressure sensor 246 omitted. The tube member 270 in this embodiment may be formed as two separate components, with each component forming one of the first and second fluid pathways 271, 272. The pneumatic module 240 also has a manifold component 280, two valves 290, a pump 244, a motor 242, and a routing component 260.

A connector 222 is formed on the manifold component 280, the manifold component 280 formed in an upper portion 281 and a lower portion 282. Optionally, the manifold component 280 may be an integrally formed, monolithic, component. The manifold component 280 further has a retention member 223 which may retain the controller 210. In addition, the manifold component 280 incorporates cantilevered portions 284 which allow simplification of the tube members 270 because the cantilevered portions 284 extend out from the body of the manifold component 280 and bend downward to approximately align with the outlet and inlet ports 261, 262 of the routing component 260. In addition, this configuration allows use of pieces of flexible or rigid tube for the tube member 270. The manifold component 280 may also incorporate a sensor port 224 to allow sensing of the pressure at the connector 222.

The valves 290 have a housing 294 which joins the manifold component 280 to the routing component 260, the housing 294 of the valves 290 sandwiched between the manifold component 280 and the routing component 260 with respect to the longitudinal axis A-A. The housing 294 is fixed to a fastening feature 266 of the routing component 260. The fastening feature 266 has fastener passageways 268 which allow use of a fastener such as a screw, bolt, or rivet to couple the housing 294 to the routing component 260. The routing component 260 also has a top surface 263 and an opposing bottom surface 267. A plurality of protuberances 265 extend from the top surface 263 to ensure that the third ports 293 of the valves 290 have a free path to atmosphere.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A personal care implement comprising:
a handle, the handle comprising:
a motor;
a pump operably coupled to the motor, the pump configured to displace air;
a routing component coupled to the pump, the routing component comprising an outlet port configured to output air and an inlet port configured to intake air;
a first valve coupled to the routing component;
a second valve coupled to the routing component; and
a controller comprising a processor and a memory, the controller configured to operate the motor, the first valve, and the second valve; and
a head coupled to the handle, the head comprising a plurality of cleaning elements and a bladder;
wherein the first and second valves are configured to permit selective pressurization or depressurization of the bladder by the pump.

2. The personal care implement according to claim 1 wherein each of the first valve and the second valve are three port, two position valves.

3. The personal care implement according to claim 1 wherein the first and second valves are solenoid valves.

4. The personal care implement according to claim 1 wherein the first and second valves each comprise a first port, the first port of the first valve fluidly coupled to the outlet port of the routing component and the first port of the second valve fluidly coupled to the inlet port of the routing component.

5. The personal care implement according to claim 1 wherein the first and second valves each comprise a second port, the second ports of the first and second valves fluidly coupled to the bladder.

6. The personal care implement according to claim 1 wherein the handle further comprises a pressure sensor fluidly coupled to the bladder.

7. The personal care implement according to claim 1 wherein the handle further comprises a manifold component, the manifold component fluidly coupled to the first valve, the second valve, and the routing component.

8. The personal care implement according to claim 7 wherein the manifold component comprises a connector, the connector receiving a connector of the head to provide fluid communication between the bladder and the first and second valves.

9. The personal care implement according to claim 7 wherein a pressure sensor is coupled to the manifold component.

10. The personal care implement according to claim 7 wherein the manifold component is fluidly coupled to the routing component via a tube member, the tube member comprising first and second passageways.

11. The personal care implement according to claim 1 wherein the handle extends along a longitudinal axis, the longitudinal axis extending through the motor, the pump, the routing component, and a manifold component coupled to the first and second valves.

12. The personal care implement according to claim 11 wherein the longitudinal axis extends through a connector of the manifold component.

13. The personal care implement according to claim 11 wherein the manifold component comprises retention features which engage the first and second valves.

14. The personal care implement according to claim 11 wherein the first and second valves are in direct surface contact with the routing component and the manifold component.

15. The personal care implement according to claim 11 wherein the first and second valves are located between the routing component and the manifold component with respect to the longitudinal axis.

16. The personal care implement according to claim 11 wherein a tube member extends from the routing component to the manifold component, the tube member extending parallel to the first and second valves with respect to the longitudinal axis.

17. A pneumatic module for a personal care implement, the pneumatic module comprising:
a motor;
a pump operably coupled to the motor, the pump configured to displace air;
a routing component coupled to the pump, the routing component comprising an outlet port configured to output air and an inlet port configured to intake air;
a manifold component comprising a connector;
a first valve coupled to the routing component via the manifold component; and
a controller comprising a processor and a memory, the controller configured to operate the motor and the first valve;
wherein the first valve is selectively operated to output or intake air at the connector during operation of the pump.

18. The pneumatic module according to claim 17 further comprising a longitudinal axis, the longitudinal axis extending through the motor, the pump, the routing component, and the manifold component, wherein the longitudinal axis extends through the connector of the manifold component, wherein the first valve is located between the routing component and the manifold component with respect to the longitudinal axis, and wherein a tube member extends from the routing component to the manifold component, the tube member extending parallel to the first valve with respect to the longitudinal axis.

19. A method of operating a personal care implement comprising:
a) displacing air from a pump via an outlet port of a routing component;
b) routing the air from the outlet port through a manifold component to a first valve;
c) directing the air from the first valve to a bladder on a head of the personal care implement via the manifold component, causing the bladder to expand in a first state;
d) switching to a second state, wherein in the second state, the air from the bladder moves through a second valve via the manifold component; and
e) drawing the air through an inlet port of the routing component and into the pump.

20. The method according to claim 19 further comprising step f), step f) comprising venting the air through the first valve to an ambient environment via the pump, the outlet port of the routing component, and the manifold component, wherein step f) occurs substantially simultaneously with step e).
